(19) United States
(12) Patent Application Publication
(10) Pub. No.: US 2005/0081196 A1
(43) Pub. Date: Apr. 14, 2005

(54) Program redirection and modification method for embedded processors with a limited amount of static random access memory

(76) Inventors: Hong-Tsan Lee, Hsinchu (TW); Peng-Cheng Chen, Hisnchu (TW)

Correspondence Address: HERSHKOVITZ & ASSOCIATES, 1725 I STREET NW, SUITE 300, WASHINGTON, DC, 20006, US

(21) Appl. No.: 10/842,499

(22) Filed: May 11, 2004

(30) Foreign Application Priority Data
Oct. 13, 2003 (TW) 092128246

(51) Int. Cl. G06F 9/44

(52) U.S. Cl. 717/168; 717/162; 717/124

(57) ABSTRACT

A program redirection and modification method for embedded processors with a limited amount of SRAM sets at least one address in a program of ROM to an origin address of at least one register. To redirect the embedded processor to execute another section in the program in ROM or SRAM, a destination address of the register is set to another address of the program in ROM or a program in the SRAM. Therefore, the embedded processor sets the addresses in the register and then the program in ROM can debugged or extended to an external program.

### BACKGROUND OF THE INVENTION

1. Field of the Invention

The present invention relates to an embedded processor's program redirection and modification method, and more particularly to a program redirection and modification method for an embedded processor with a limited amount of static random access memory (SRAM).

2. Description of Related Art

There are several options for storing the program for an embedded processor. The most flexible way is to use an internal static random access memory (SRAM) for the whole program and download the program from an external read only memory (ROM) to the internal SRAM after power turned on each time. However, this approach requires very large chip area so another extreme idea is to employ the internal ROM for the whole program area, which occupies the least chip area but lacks the flexibility to change the program. Another approach uses flash memory, which compromises between the area and the flexibility but is also an expensive solution in terms of extra process and testing costs.

For a near-mature system, the cost-effective ROM approach is preferred because large-scale changes in the program of the embedded processor are unlikely. Instead, a short code sequence may need to be inserted into the existing program to fix a bug or test a new feature.

To meet the requirement for the embedded processor, the present invention provides a program redirection and modification method for embedded processors with a limited amount of static random access memory.

### SUMMARY OF THE INVENTION

The main objective of the present invention is to provide a program redirection and modification method for embedded processor that allows the embedded processor to employ a limited amount of static random access memory (SRAM) and be able to fix a bug or run a new feature.

Other objectives, advantages and novel features of the invention will become more apparent from the following detailed description when taken in conjunction with the accompanying drawings.

### BRIEF DESCRIPTION OF THE DRAWINGS

FIG. 1 is a block diagram of an embedded processor in accordance with the present invention;

FIG. 2 is a flow chart of a program redirection and modification method in accordance with the present invention; and

FIG. 3 is an address arrangement drawing of memory of the embedded processor in accordance with the present invention.

### DETAILED DESCRIPTION OF THE PREFERRED EMBODIMENT

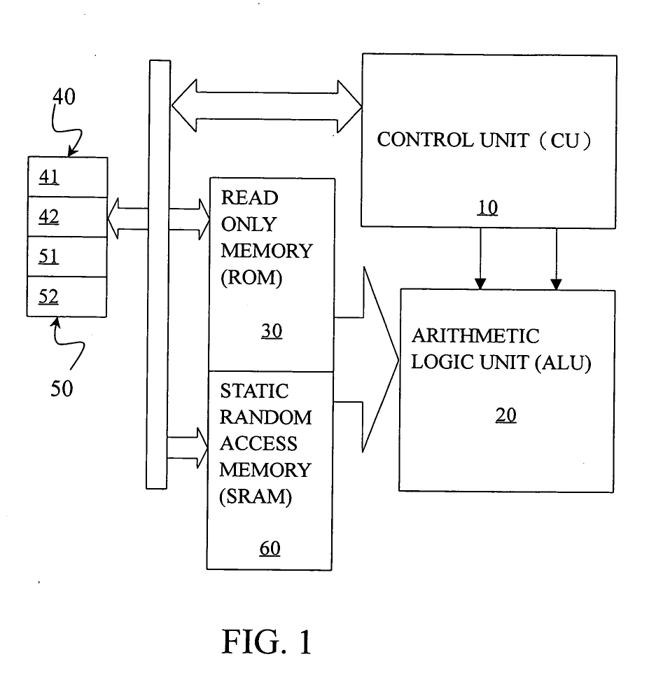

With reference to FIG. 1, a preferred embodiment of a program redirection and modification method for an embedded processor in accordance with the present invention is used with a general processor (not numbered), at least one register (40, 50) and a static random access memory (SRAM) (60). The general processor has a control unit (10), an arithmetic logic unit (ALU) (20) and a read only memory (ROM) (30). The ROM (30) has a size, and the SRAM (60) has a size smaller than that of the ROM (30). The ROM (30) stores a program, and the SRAM (60) stores an external program.

Each register (40, 50) is connected to the ROM (30) and control unit (10) through an address bus (not numbered) and has at least one origin address (41, 5 1) and at least one destination address (42, 52). The SRAM (60) is connected to the ROM (30) and the register (40, 50) through the address bus (not numbered). Since the SRAM (60) is smaller than the ROM (30), the SRAM (60) does not occupy a very large chip area of the embedded processor.

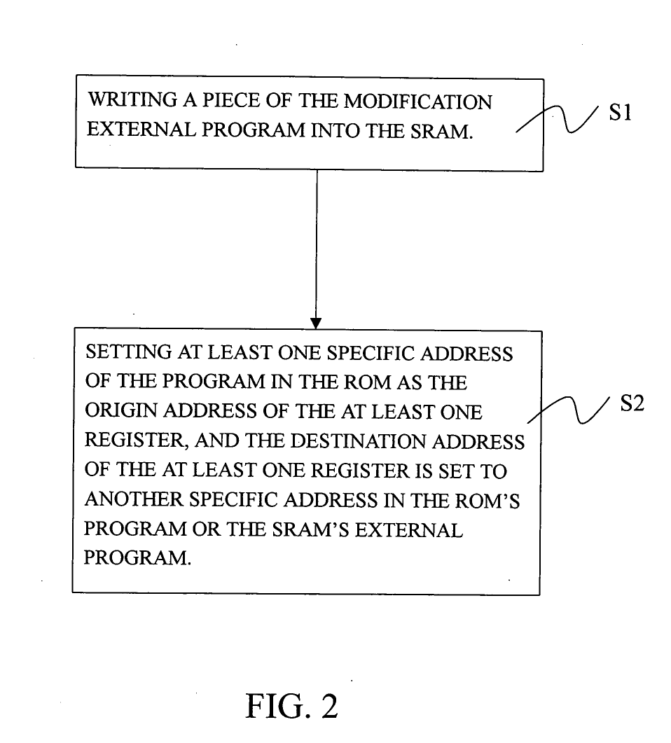

With reference to FIG. 2, the program redirection and modification method used in the forgoing embedded processor comprises steps of:
(S1) writing a piece of the modification external program into the SRAM; and
(S2) setting at least one specific address of the program in the ROM as the origin address of the at least one register, and the destination address of the at least one register is set to another specific address in the ROM's program or the SRAM's external program.

According to the forgoing method, the present invention provides at least three redirected or modified program functions for a program in the ROM.

(A) Debugging Program Function:

A known bug has a start address and an end address. Based on the forgoing steps of the method, the start address of a bug is redirected to the end address of the bug by setting the origin address in the register to the start address of the bug and setting the destination address in the register to the end address of the bug. Therefore, the origin and destination addresses of the first register are mapped to the start and end addresses of the bug program.

When the program reaches the start address of the bug, the program will be redirected to the first register according to the origin address and then jump back to the program after the end address of the bug address in the ROM according to the destination address. Therefore, the bug will not be executed, and the programmer can use this function to isolate one or more program segments.

(B) Expanding at Least One External and New Program Function:

Based on the forgoing steps of the method, a specific address in the program in ROM is redirected to the origin address in one register, and a start address of an external program in the SRAM is set to the destination address of the register. The external program in the SRAM jumps back to the program in the ROM by either of two techniques. A specific address of the program in ROM may be written into the end address of the external program. Alternately, the end address of the external program may be set to the origin address in another register, and the destination address in the register may be set to the appropriate address in the program in ROM.

When the program reaches the specified address in the program, the specified address is redirected to the first register and is redirected to the start address of the external program. Therefore, the control unit will execute the external program until the end address causes the external program to jump back to the specific address in the program in ROM.

(C) Modifying a Program Function:

To implement this function the first and second registers are required. Essentially, the modifying a program function combines the two previously described functions (A, B). The start address of a function to be modified is directed around the function to be modified, so the origin and destination addresses of the first register are mapped respectively to the start and end addresses of the function. To make the control unit execute the external program, a specific address in the program in ROM is redirected to execute the modified or relocated function. Therefore, the origin address of the second register is mapped to the origin address in the second register, and the destination addresses of the second register is set to the start address an external program in the SRAM containing the modified. The end address of the external program is set to the specific address in the program in ROM.

When the control unit executes the program in the ROM and the program reaches the start address of the function to be modified or relocated, the control unit will jump around the function and execute the next sequence in the program in ROM according to the destination address of the first register. When the program encounters the specific address, the control unit will be redirected to execute the external program in the SRAM by the second register. The end address of the external program returns program execution to the specific address in the program in ROM. Thus, the control unit modifies one or more internal program sequences in the ROM.

Based on the forgoing three functions, the present invention can debug, extend or modify a program in ROM by using a limited amount of SRAM. Each function can be implemented in an embedded processor, and all three functions can be implemented in one embedded processor. When the three functions are implemented in one embedded processor, the origin address of one register is mapped to one address in the program in ROM if the embedded processor only uses the debug function (A) or implements a new, modified or corrected function (B). Further, if the embedded processor uses the function to modify a program (C), the two registers are employed.

For the function to modify a program (C), the embedded processor also employs one register. The origin address in the register is set as the start address of a segment of a program to be modified. The destination address in the first register directs program operation to the start of a modified program segment resident in SRAM. The end address of the modified program in SRAM redirects program operation to the end of the program segment in ROM that is modified. The one register with an enable terminal, which is controlled through the enable terminal to enable to redirect program to the extra program in the SRAM.

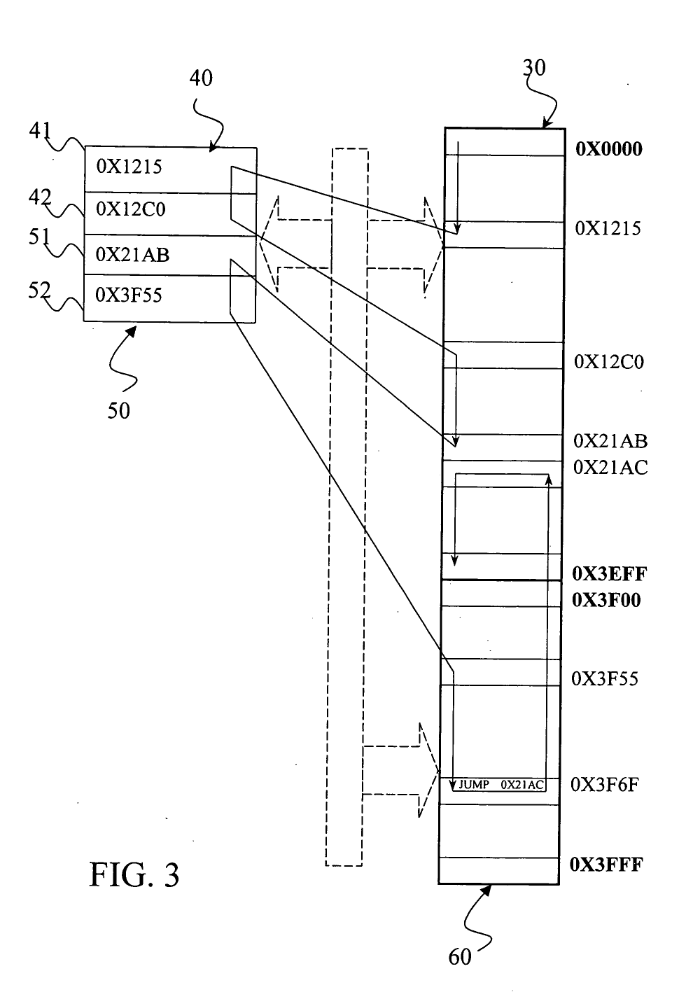

With reference to FIG. 3, an example of the function to modify a program (C) follows. The example shows how to bypass one program segment in ROM (30) and in insert a selected program segment in SRAM (60) into a ROM program. In the example, a ROM program is resident from 0X0000 to 0X3EFF, and a limited amount of SRAM (60) is available with addresses from 0X3F00 to 0X3FFF. A segment of the program in ROM (30) to be bypassed is located from 0X1215 to 0X12C0. A segment of code to be inserted into the program in ROM (30) at location 0X21AB is located in SRAM (60) from 0X3F55 to 0X3F6F.

An address bus (not numbered) connects the ROM (30), the SRAM (60), a first register (40) and a second register (50). The first and second registers (40, 50) respectively have origin addresses (41, 51) and destination addresses (42, 52).

The origin address (41) in the first register (40) is set to the start address (0X1215) of the program in ROM (30) to be bypassed, and the destination address (42) of the first register (40) is set to the end address 0X12C0 of a program to be bypassed. Therefore, the program in the ROM will be redirected to the first register (40) that redirects program execution to the end address 0X12C0. Therefore, the program located between 0X1215 and 0X12C0 is not executed by a redirecting address method.

To insert a segment of code into the program in ROM (30), the origin address (51) in the second register (50) is set to the address in ROM (30) (0X21AB) where the segment of code is to be executed. The destination address (52) of the second register (50) is set to a start address (0X3F55) of the segment of code in SRAM (60). To return execution of the program to the program in ROM (30), a return command is used in the end address (0X3F6F) of the segment of code in SRAM (60) to return execution of the program to a specific address (0X21AC) in the program in ROM (30).

When the program reaches the location (0X21AB) where the segment of code in SRAM (60) is to be executed, the program is redirected to the start address (0X3F55) of the segment of code in SRAM (60) through the second register (50). The end address (0X3F6F) of the external segment of code returns execution to the specific address (0X21AC) in the program in the ROM (30) to execute the remaining program from the specific address (0X21AC).

The present invention can be used to debug a program by employing a register with mapping addresses mapped to the ROM and extend or modify a program by using a limited amount of SRAM. That is, the forgoing functions can be implemented in an embedded processor that employs low cost ROM by just adding a register and a small amount of SRAM. Therefore, the present invention provides a new and effective program redirection and modification method for embedded processors with ROM.

Even though numerous characteristics and advantages of the present invention have been set forth in the foregoing description, together with details of the structure and function of the invention, the disclosure is illustrative only, and changes may be made in detail, especially in matters of shape, size, and arrangement of parts within the principles of the invention to the full extent indicated by the broad general meaning of the terms in which the appended claims are expressed.

1. A program redirection and modification method for embedded processors with a limited amount of static random access memory (SRAM), wherein the embedded processor further has a control unit, an arithmetic logic unit, read only memory (ROM) with a program and at least one register having an origin address and a destination address, comprising steps of:
writing at least one external program in the SRAM that has a start address and an end address; and
setting at least one specific address of the program in the ROM as the origin address of the at least one register, and the destination address of the at least one register is set to another specific address in the ROM's program or the SRAM's external program;
whereby when the program reaches the specific address, the program is redirected to the other specific address in the program or the start address of the external program to implement an extending and modifying program in the ROM.

2. The method as claimed in claim 1, wherein the embedded processor has a first register having an origin address and a destination address, wherein
the origin and destination addresses are set respectively to a start address and an end address of a segment of code in the program in ROM.

3. The method as claimed in claim 1, wherein the embedded processor has a second register having an origin address and a destination address, wherein
the origin address is set to a specific address in the program in ROM and the destination address is set to a start address in the external program in SRAM;
whereby the external program is executed, and program execution returns to the program in ROM by a command in the end address of the external program.

4. The method as claimed in claim 2, wherein the embedded processor has a second register having an origin address and a destination address, wherein
the origin address is set to a specific address in the program in ROM, and the destination address is set to a start address in the external program in SRAM;
whereby the external program is executed, and program execution returns to the program in ROM by a command in the end address of the external program.

5. The method as claimed in claim 1, wherein the embedded processor has two registers having respectively first and second origin addresses and first and second destination addresses; wherein
the first origin and destination addresses are respectively set to a start and end addresses of a section of the program in ROM to bypass the section of the program; and
the second origin address is set to a specific address in the program in ROM where an external segment of code in SRAM is to be executed and the second destination address is set to a start address of the external segment of code in SRAM;
whereby the external segment of code in SRAM is executed and returns to the program by a command in the end address of the external segment of code.

6. The method as claimed in claim 1, wherein the embedded processor has a first register and second register, each of which has an origin address and a destination address, wherein
the origin and destination addresses of the first register are set respectively to a start address and an end address of a section of the program in the ROM to be bypassed; and
the origin address of the second register is set to a specific address of the program in ROM at which an external program is to be executed and the destination address of the second register is set-to-a start address of the external program in SRAM;
whereby the external program is executed, and program execution returns to the program in ROM by a command in the end address of the external program.

7. The method as claimed in claim 6, wherein each register has an enable terminal, which is controlled by an outer control signal through the enable terminal.

8. The method as claimed in claim 1, wherein the ROM has a size, and the SRAM has a size smaller than the ROM.
